(19) United States
(12) Patent Application Publication
(10) Pub. No.: US 2023/0332635 A1
(43) Pub. Date: Oct. 19, 2023

(54) Drywall Sleeve Anchor

(71) Applicant: Robert Tzorany, Tel Aviv (IL)

(72) Inventor: Robert Tzorany, Tel Aviv (IL)

(21) Appl. No.: 17/722,475

(22) Filed: Apr. 18, 2022

(51) Int. Cl. F16B 13/06

(52) U.S. Cl. CPC F16B 13/061

(57) ABSTRACT

A drywall sleeve anchor, comprising: a bolt; a sleeve, comprising: a first opening at a first end thereof; a second opening at a second end thereof; at least one slit placed between the first end and the second end; and a nut; wherein the bolt is configured to pass through the first end and the second end and to be screwed into the nut; and wherein upon screwing the bolt into the nut, the nut is configured to progress toward the second end and push the second end toward the first end, thereby bending the sleeve.

### FIELD OF THE INVENTION

The present invention generally relates to wall anchors and specifically to drywall sleeve anchors.

### BACKGROUND

Wall anchors or wall fasteners are well known and widely used for creating a firm mount on a wall, a drywall (also known as plasterboard, wallboard, sheet rock, gypsum board, buster board, custard board, or gypsum panel), etc. Such anchors include, for example, Cement Board Screw Anchors, Expansion Anchors, Hollow Wall Anchors, Plastic Hollow Wall Plugs, Threaded Drywall Anchors, Toggle Bolts, Winged Plastic Anchors, Self-Drilling Anchors, Spring Anchors, Sleeve Anchors and more.

Each one of these anchors has a different mechanism, is intended to be used with a different wall material and structure, to enable hanging different loads and more.

In the field of drywall anchors, different types of anchors enable hanging different loads, using different mechanisms each has its own disadvantages.

The Toggle Bolt, for example, has wings having sharp edges such that if the user tightens the bolt more than necessary, those edges might cut the drywall.

The Plastic Hollow Wall Plug, for example, is intended to be used with relatively light loads and might be torn if used with electric screwdriver.

The Drywall Rosett Anchor, for example, has to be inserted into the wall along with the item it should hold and might be pulled out of the wall if the item is heavy due to its elastic structure.

The Drywall Arrow Anchor, for example, is intended to be used with small screws and relatively light loads due to its small dimensions and low resistance.

For all of the above reasons and more, there is a need for the strong, easy to use drywall sleeve anchor of the present invention.

### SUMMARY

According to an aspect of the present invention there is provided a drywall sleeve anchor, comprising: a bolt; a sleeve, comprising: a first opening at a first end thereof; a second opening at a second end thereof; at least one slit placed between the first end and the second end; and a nut; wherein the bolt is configured to pass through the first end and the second end and to be screwed into the nut; and wherein upon screwing the bolt into the nut, the nut is configured to progress toward the second end and push the second end toward the first end, thereby bending the sleeve.

The sleeve may be made of softer material than of the bolt.

The nut may be in a shape of a cone.

The first end of the nut, facing the sleeve, may be texture or may comprise ridges.

The drywall sleeve anchor may further comprise at least one fin at the first end.

The at least one slit may be longitudinal.

The at least one slit may be helical.

Optionally, the greater the friction between the nut and the second end, the greater the rotation of the sleeve.

The sleeve may be made of plastic.

The inner circumference of the sleeve may be smaller than an outer circumference of the nut.

The bolt may comprise a head having a shape selected from the group consisting of: “L” shape, “J” shape, hook shape, eye hook shape, and all-grip hook shape.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 shows a schematic side view of a drywall sleeve anchor, according to is embodiments of the present invention;

FIG. 2 shows an exploded view of the drywall sleeve anchor, according to embodiments of the present invention;

FIG. 3 shows a top view of bolt 110;

FIG. 4 shows a top view of washer 120;

FIG. 5 shows a top view of sleeve 130;

FIG. 6 shows a top view of the nut 140;

FIG. 7A shows a front perspective view of the process of installing the drywall sleeve anchor, according to embodiments of the present invention;

FIG. 7B shows a rear perspective view of the process of installing the drywall sleeve anchor, according to embodiments of the present invention;

FIG. 7C shows an enlargement of steps 740 to 770 of FIG. 7B;

FIG. 8 shows a 3D imaging, illustrating stages in fastening of three different exemplary sleeve anchors, according to embodiments of the present invention; and

FIG. 9 shows a schematic side view of an exemplary drywall sleeve anchor, according to embodiments of the present invention.

### DETAILED DESCRIPTION OF PREFERRED EMBODIMENTS

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is applicable to other embodiments or of being practiced or carried out in various ways. Also, it is to be understood that the phraseology and terminology employed herein is for the purpose of description and should not be regarded as limiting.

The term ‘bolt’ or ‘bolt fastener’ used hereinbelow refers to a threaded fastener in a form of an elongated rod surrounded by a helical ridge (also known as a male thread or an external thread) requiring a matching female thread nut. It will be appreciated that the bolt of the present invention is not limited to include a male thread or an external thread requiring a matching female thread nut, and alternatively may include a female thread or an internal thread requiring a matching male thread nut.

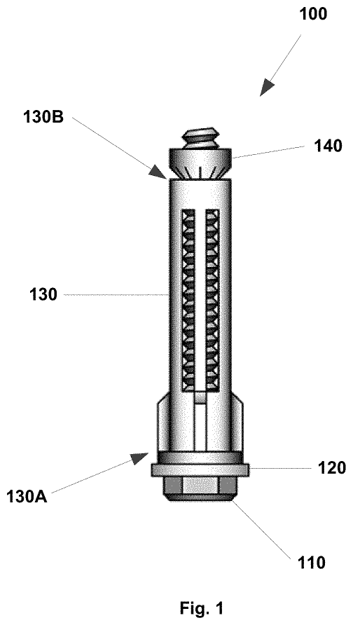

FIG. 1 shows a schematic side view of a drywall sleeve anchor 100, according to embodiments of the present invention.

The drywall sleeve anchor 100 comprises a bolt 110 comprising a thread, a washer 120, a sleeve 130, and a nut 140 comprising a matching thread.

The bolt 110 is intended to pass through the washer 120, into the sleeve 130 through a first end 130A, and to be screwed into a nut 140 placed at the second end 130B of the sleeve 130.

It will be appreciated that the bolt 110 is longer than the sleeve 130, in order to allow the bolt to pass through the first and second ends of the sleeve 130 and meet the nut 140.

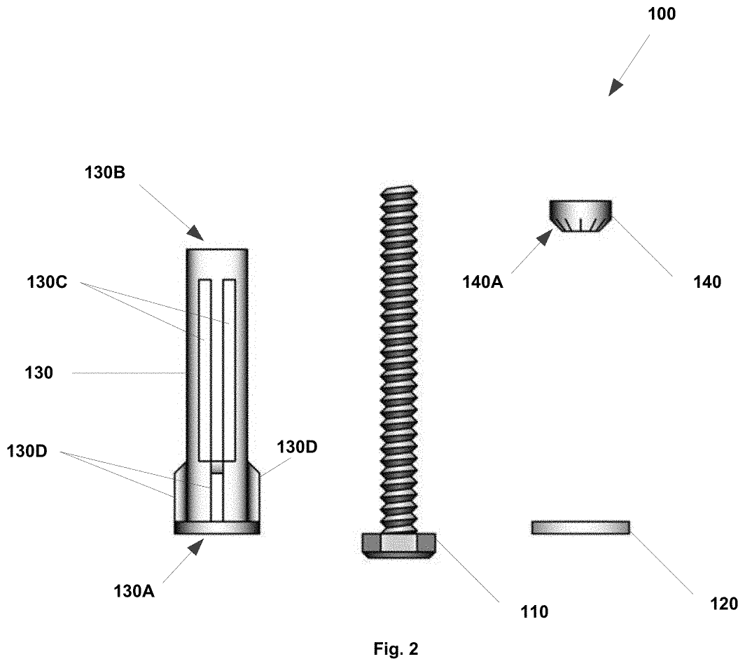

FIG. 2 shows an exploded view of the drywall sleeve anchor 100, according to embodiments of the present invention.

It will be appreciated that the washer 120 may be made of various rigid materials such as plastic, metal, and the like, and is not limited to a specific type of washer. It will also be appreciated that the drywall sleeve anchor 100 is not limited to include a washer.

According to embodiments of the present invention, the end 140A of the nut 140, facing the sleeve 130, may be in a shape of a cone, but is not limited to be in a shape of a cone.

According to embodiments of the present invention, the end 140A of the nut 140, facing sleeve 130, may be textured or may comprise ridges in order to better grip the second end of sleeve 130 as will be explained below, but is not limited to be textured or to comprise ridges.

Alternatively or additionally, according to embodiments of the present invention, the inner circumference of the second end 130B of sleeve 130 may be a bit smaller than the outer circumference of nut 140, thereby, allowing nut 140 to grip the second end 130B of sleeve 130 when the bolt 110 is screwed and the nut 140 progresses toward first end 130A of sleeve 130.

It will be appreciated that sleeve 130 is made of a firm material, but flexible, in order to allow the sleeve 130 to behave as will be explained in detail below.

According to embodiments of the present invention, sleeve 130 may comprise at least one slit 130C (two are shown) allowing the sleeve to bent or be twisted as will be explained below.

According to embodiments of the present invention, sleeve 130 may comprise at least one fin 130D (three are shown), for fixing the first end 130A of sleeve 130 to a drywall while the bolt 110 is being screwed, through sleeve 130, into nut 140. When sleeve 130 is inserted into a hole in the wall, at least one fin 130D, constituting a part of the sleeve, fixes the sleeve to the wall and prevents rotation of the first end 130A of sleeve 130.

The at least one fin 130D counters the rotational force created by nut 140 during the installment of the drywall sleeve anchor 100 as will be explained below.

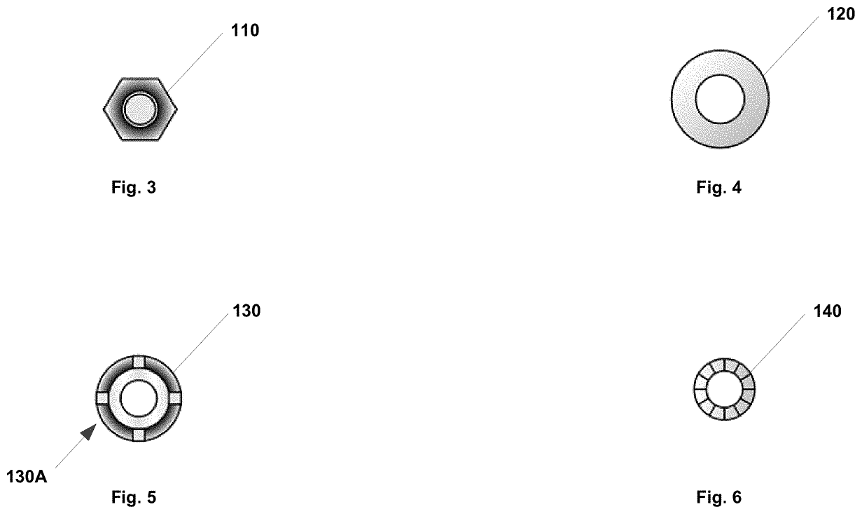

FIG. 3 shows a top view of bolt 110.

It will be appreciated that the head of the bolt may comprise, alternatively or additionally to its shape, an indentation enabling to fasten the bolt using a screwdriver or an electric screwdriver. It will also be appreciated that the head of the bolt may be in a shape of an “L”, “J”, hook, eye hook, allgrip hook, and the like and is not limited to the shown head.

FIG. 4 shows a top view of washer 120.

FIG. 5 shows a top view of sleeve 130.

FIG. 6 shows a top view of the nut 140.

It will be appreciated that the top of the nut is not limited to have any texture.

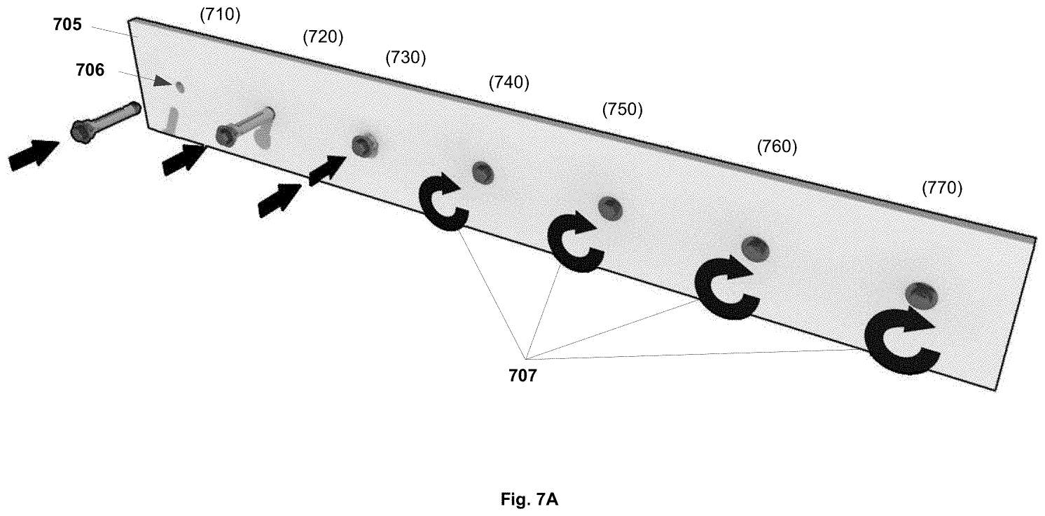

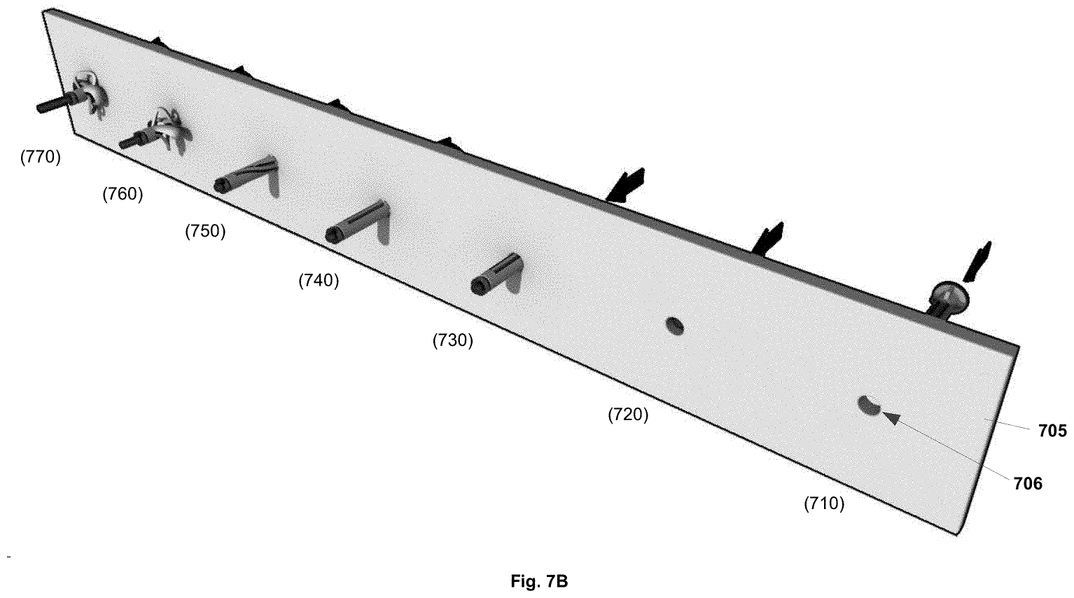

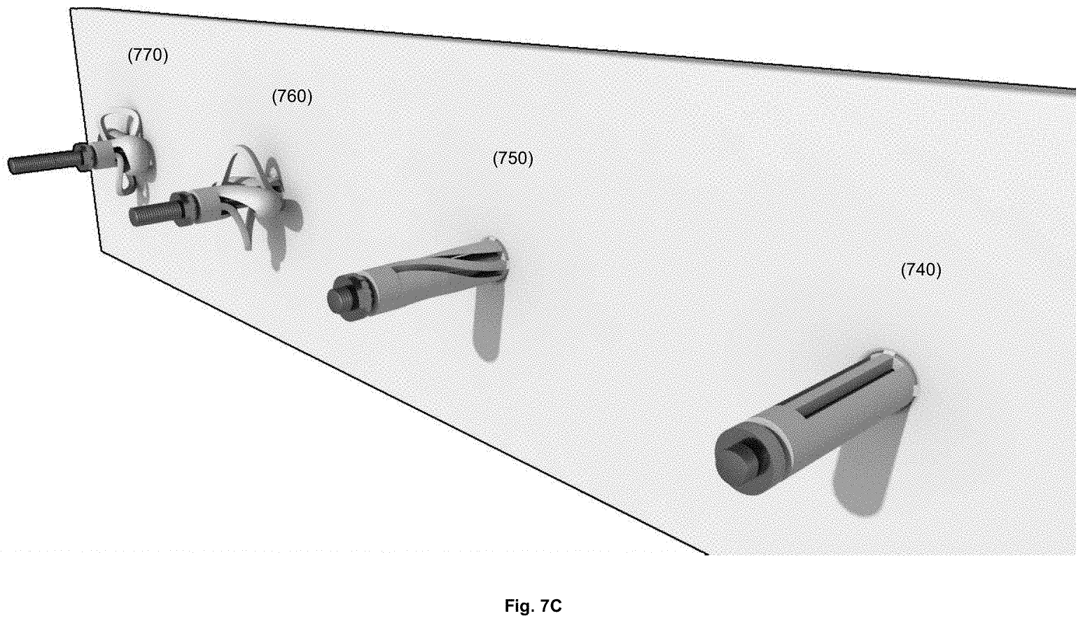

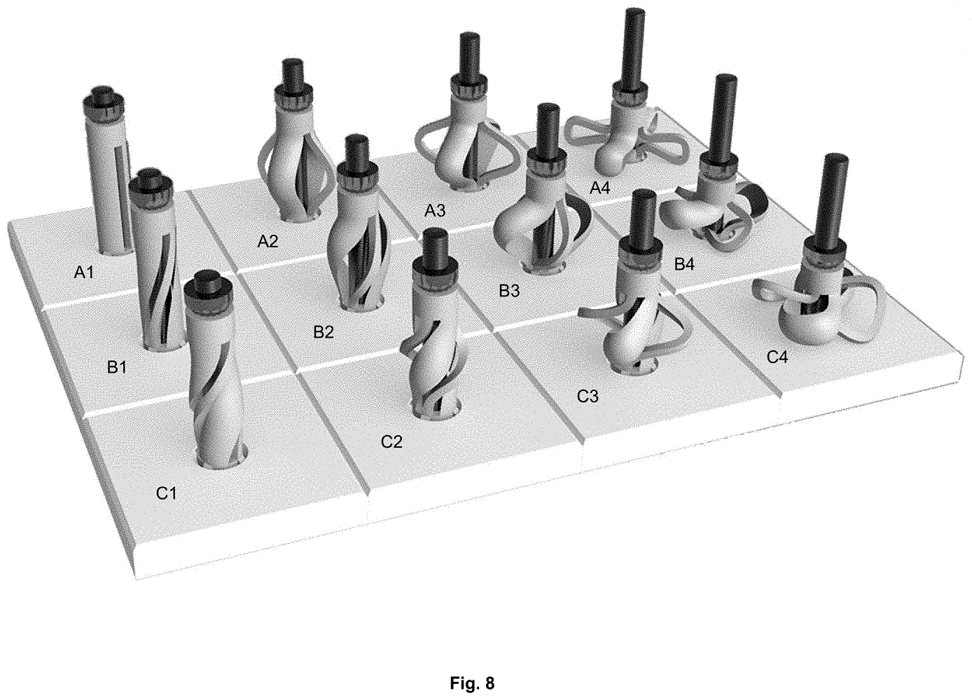

FIG. 7A shows a front perspective view and FIG. 7B shows a rear perspective view of the process of installing the drywall sleeve anchor 100, according to embodiments of the present invention.

As mentioned above, bolt 110 is longer than sleeve 130 in order to allow the tip of the bolt to reach and be screwed into nut 140. By continuing screwing bolt 110, the second end 130B of sleeve 130 is pushed by nut 140 which progresses toward the first end 130A of sleeve 130, causing sleeve 130 to bend. As mentioned above, according to embodiments of the present invention, due to friction between nut 140 and the second end 130B of sleeve 130, the second end 130B of sleeve 130 not only bends but may also twist.

FIGS. 7A and 7B show a wall 705 into which the drywall sleeve anchor 100 is installed and the steps of installing the drywall sleeve anchor 100 of the present invention.

In step 710, hole 706 is prepared in wall 705. The diameter of the hole essentially corresponds to the diameter of the drywall sleeve anchor 100.

In step 720, the drywall sleeve anchor 100 is placed into hole 706.

In step 730, the drywall sleeve anchor 100 is inserted into wall 705 (e.g., using a hammer, not shown) such that in step 740, the washer 120 or the first end 130A reaches the surface of wall 705. As mentioned above, according to embodiments of the present invention, at least one fin 130D may fixate the drywall sleeve anchor 100 to the wall 705.

In steps 740 to 770, a user screws bolt 110 in the direction of arrow 707.

Attention is drawn to FIG. 7C showing an enlargement of steps 740 to 770 of FIG. 7B.

As can be seen, when the user screws the bolt 100, the nut 140 progresses toward the first end 130A of sleeve 130, and the sleeve 130 starts to bend. As mentioned above, according to embodiments of the present invention, due to friction between the nut 140 and the second end 130B of sleeve 130, the nut 140 grabs the second end 130B and twists the sleeve 130. As the user continues screwing the bolt 110, the nut 140 progresses toward the first end 130A of the sleeve 130 and twists the sleeve 130 more and more to create a strong shape configured to hold the sleeve 130 firmly to the wall 705.

The diameter of the created shape is derived from the friction between the nut 140 and the second end 130B of sleeve 130.

FIG. 8 shows a 3D imaging, illustrating stages in fastening of three different exemplary sleeve anchors, according to embodiments of the present invention.

The figure shows three sets of squares, A1 to A4, B1 to B4, and C1 to C4. Each square represents a gypsum board.
Squares A1 to A4 show a wall anchor comprising straight slits having low friction between the nut 140 and the second end 130B thereby creating a shape of a plus sign.
Squares B1 to B4 show a wall anchor comprising slightly helical slits having higher friction between the nut 140 and the second end 130B thereby creating a shape of a “flower”.
Squares C1 to C4 show a wall anchor comprising more helical slits having higher friction between the nut 140 and the second end 130B thereby creating a shape of a more twisted “flower”.

Therefore, the following factors may have an impact on the twist of the sleeve 130:
The sleeve 130 material characteristics, such as, hardness and flexibility;
The number of slits (130C);
The friction between the nut 140 and the second end 130B of the sleeve 130.
The inner circumference of the second end 130B of sleeve 130 and the outer diameter of the nut 140.
The initial shape of the slits. According to embodiments of the present invention, the at least one slit 130C may be straight or twisted (as shown in FIG. 8).

It will be appreciated that the drywall sleeve anchor of the present invention may include any shape of slits, any level of friction between the nut 140 and the second end 130B, any method of achieving that friction, any material characteristics, any number of slits, etc.

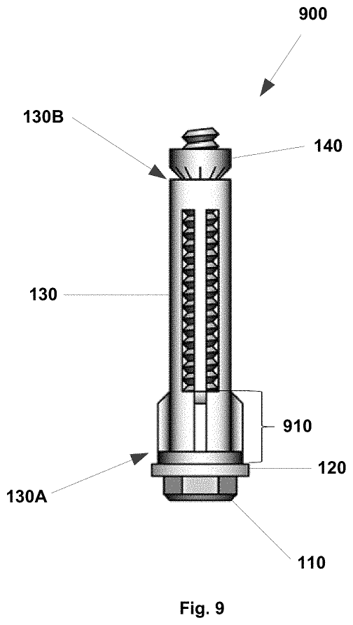

FIG. 9 shows a schematic side view of an exemplary drywall sleeve anchor 900, according to embodiments of the present invention.

According to embodiments of the present invention, the length of the base 910, which is the distance between the first end 130A and the beginning of the nearest slit may be identical to the thickness of a standard drywall. This feature allows the bars not to bend inside the bore in the drywall, and therefore not to harm the drywall, which is made of a soft material.

It will be appreciated by persons skilled in the art that the present invention is not limited to what has been particularly shown and described hereinabove. Rather the scope of the present invention is defined by the appended claims and includes combinations and sub-combinations of the various features described hereinabove as well as variations and modifications thereof which would occur to persons skilled in the art upon reading the foregoing description.

1. A drywall sleeve anchor, comprising:
a bolt;
a sleeve, comprising:
a first opening at a first end thereof;
a second opening at a second end thereof;
at least one slit placed between said first end and said second end;
and
a nut;
wherein said bolt is configured to pass through said first end and said second end and to be screwed into said nut; and
wherein upon screwing said bolt into said nut, said nut is configured to progress toward said second end and push said second end toward said first end, thereby bending said sleeve.

2. The drywall sleeve anchor of claim 1, wherein said sleeve is made of softer material than of said bolt.

3. The drywall sleeve anchor of claim 1, wherein said nut is in a shape of a cone.

4. The drywall sleeve anchor of claim 1, wherein a first end of said nut, facing said sleeve, is texture or comprises ridges.

5. The drywall sleeve anchor of claim 1, further comprises at least one fin at said first end.

6. The drywall sleeve anchor of claim 1, wherein said at least one slit is longitudinal.

7. The drywall sleeve anchor of claim 1, wherein said at least one slit is helical.

8. The drywall sleeve anchor of claim 1, wherein the greater the friction between said nut and said second end, the greater the rotation of said sleeve.

9. The drywall sleeve anchor of claim 1, wherein said sleeve is made of plastic.

10. The drywall sleeve anchor of claim 1, wherein an inner circumference of said sleeve is smaller than an outer circumference of said nut.

11. The drywall sleeve anchor of claim 1, wherein said bolt comprises a head having a shape selected from the group consisting of: “L” shape, “J” shape, hook shape, eye hook shape, and all-grip hook shape.
